(19) United States
(12) Patent Application Publication
(10) Pub. No.: US 2006/0039469 A1
(43) Pub. Date: Feb. 23, 2006

(54) Scalable video compression based on remaining battery capacity

(75) Inventor: Godert Willem Renswoud Leibbrandt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/535,469

(22) PCT Filed: Oct. 27, 2003
(86) PCT No.: PCT/IB03/04812

§ 371 Date: May 17, 2005

(30) Foreign Application Priority Data
Nov. 21, 2002 (EP) 02079850.0

(51) Int. Cl. H04N 7/12; H04N 11/04; H04B 1/66; H04N 11/02

(52) U.S. Cl. 375/240.08; 375/240.01

(57) ABSTRACT

A method and apparatus for controlling the recording of streaming data by a mobile recording apparatus is disclosed. A streaming data input signal is received and the streaming data signal is compressed in a scalable manner using a scalable encoder to create layered encoded streaming data streams. Storage of the layered encoded streaming data streams is begun in a storage device at a first bit-rate. The remaining battery life for the apparatus is determined at the first bit-rate. The bit rate is reduced to a second bit-rate by stopping the storage of at least one of the layered encoded streaming data streams to lengthen the remaining battery life of the apparatus.

### FIELD OF THE INVENTION

The invention relates to video compression.

### BACKGROUND OF THE INVENTION

Many video applications are enabled where video is available at various resolutions and/or qualities in one stream. Methods to accomplish this are loosely referred to as scalability techniques. There are three axes on which one can deploy scalability. The first is scalability on the time axis, often referred to as temporal scalability. Secondly, there is scalability on the quality axis (quantization), often referred to as signal-to-noise (SNR) scalability or fine-grain scalability. The third axis is the resolution axis (number of pixels in image) often referred to as spatial scalability. In layered coding, the bitstream is divided into two or more bitstreams, or layers. Each layer can be combined to form a single high quality signal. For example, the base layer may provide a lower quality video signal, while the enhancement layer provides additional information that can enhance the base layer image. By compressing the video source material in a layered fashion, one or more of the layers can be discarded, hence lowering the bit-rate while the video can still be rendered, but at a lower quality level.

Bit-rate scalable compression has been proposed for elastic storage. The principles of elastic storage are described in WO 01/69939-A1. According to the elastic storage principle, a digital data item to be stored is first divided into successive data pieces of decreasing significance. Consequently, the data pieces are stored in a memory provided there is enough space to accommodate all the pieces. In case the memory does not have enough space, space is created by removing from the memory those data pieces from various items that have the lowest significance. The thus freed space is used for storing the data pieces of the data item to be stored. Preferably, an auxiliary memory is used for recording the identification data, such as file name and significance, of all the data pieces stored in the memory.

As mentioned above, elastic storage can be used in the situation where the amount of available storage is less than the amount of storage needed for recording of a certain duration at a certain quality level. Rather than reducing the duration of the recording and therefore missing part of the event being recorded, the quality level of the recorded can be lowered thus creating more space for the recording of the event.

In mobile applications, the situation may arise that the available battery power left for a video recording, e.g., as in a camcorder, or play-back session is estimated to be insufficient. For example, a certain event a user wants to capture with a camcorder will last for another 30 minutes, whereas the battery indicates only 15 minutes of power is available. Similarly, while watching a movie on a portable video player, insufficient battery power may be available to get to the end of the movie.

### SUMMARY OF THE INVENTION

The invention overcomes at least part of the deficiencies described above by providing a method and apparatus which determines when it is necessary to reduce the bit-rate during recording or play-back so as to increase the available battery lifetime. The invention is based on the insight that in recording and play-back of digital data such as audio and video, the battery power consumption is strongly determined by the data-rate. In many applications, the storage function is expected to be responsible for most of the power consumption. Thus, there is a need for a method and apparatus for lowering the data-rate of recording and play-back of digital data by a mobile recorder/video player when the remaining battery life is insufficient.

According to one embodiment of the invention, a method and apparatus for controlling the recording of streaming data by a mobile recording apparatus is disclosed. A streaming data input signal is received and the streaming data signal is compressed in a scalable manner using a scalable encoder to create layered encoded streaming data streams. Storage of the layered encoded streaming data streams is begun in a storage device at a first bit-rate. The remaining battery life for the apparatus is determined at the first bit-rate. The bit rate is reduced to a second bit-rate by stopping the storage of at least one of the layered encoded streaming data streams to lengthen the remaining battery life of the apparatus.

According to another embodiment of the invention, a method and apparatus for displaying stored content on a display, wherein the stored content has been stored in a storage device in a layered format with a base layer and at least one enhancement layer, is disclosed. Content to be displayed in a first quality level is selected. The length of the content selected is then determined. The remaining battery life of the apparatus is determined. The quality level of the content displayed is changed to a lower quality level when the remaining battery life is less than the length of the selected content.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram of a mobile recording apparatus according to one embodiment of the invention;

FIG. 2 is a block diagram of an illustrative spatial scalable video encoder according to one embodiment of the invention;

FIG. 3 is a block diagram of an elastic storage device according to one embodiment of the invention;

FIG. 4 is a flow chart illustrating the recording operation of a mobile recording apparatus according to one embodiment of the invention;

FIG. 5 is a flow chart illustrating the play-back operation of a video viewing apparatus according to one embodiment of the invention.

### DETAILED DESCRIPTION OF THE INVENTION

Reduction of the bit-rate during recording or play-back will increase the battery life-time, and thus solve the problem of insufficient battery life-time. In principle, the same bit-rate scalable compression techniques as in elastic storage can be used. As will be explained below in more detail, one difference between elastic storage and one of the embodiments of the invention is in the decision criteria to reduce the bit-rate, which is available power/battery life, rather than remaining storage capacity. Also according to the invention, bit-rate scalable video compression as a power management tool is applicable both during recording and during play-back, rather than only during recording as in elastic storage. While the illustrative description of the embodiments of the invention discuss video data, it will be understood by those skilled in the art that the invention applies to streaming data, such as audio data, audio/video data, video data, etc., and the invention is not limited thereto.

Basically, in the record mode when it is determined that the available battery-life of the mobile recorder is insufficient for the recording time required, video of lower quality is written on the storage medium. During play-back, only one or more low-quality layers are read from the medium to reduce power consumption and thus extend the battery life of the viewing apparatus.

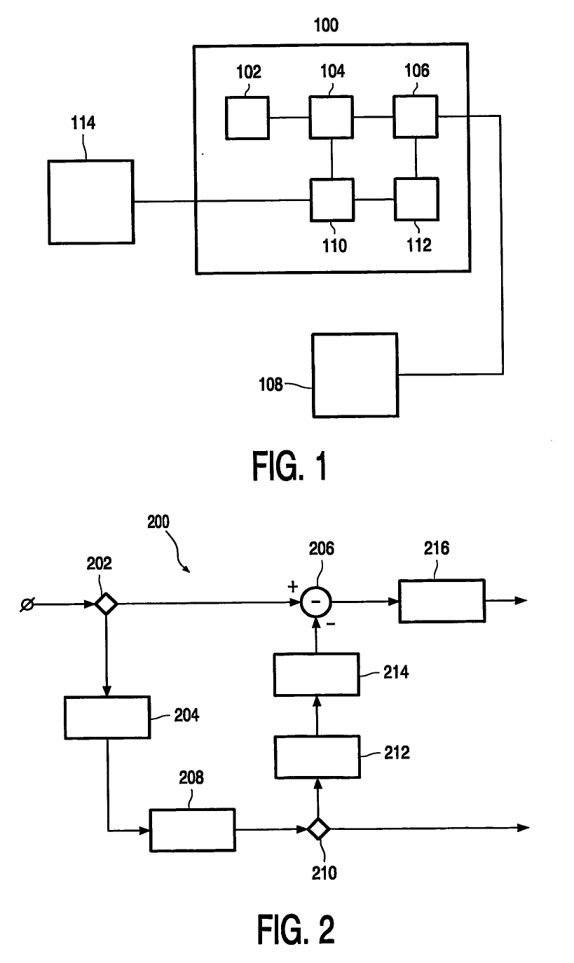

The invention relates to battery powered portable recorders/video players such as camcorders, video players, etc. An illustrative example of a camcorder with compression/decompression facility that is able to compress video in a layered fashion on an optical disc drive is illustrated in FIG. 1. Briefly, the camcorder 100 receives the input video stream which is layered encoded by an encoder 102. The layered encoded streams are stored in a storage device 104 such as an optical disc drive. The stored layered streams can be read out of the storage device 104 and decoded by a decoder 106 which sends the decoded video stream to a display 108. The operation of the encoder 102, storage device 104, the decoder 106 and optionally the display 108 is controlled by a controller 110. Furthermore, a user can enter information into the camcorder using a user interface 114. In addition, each of the described elements of the camcorder are powered by a battery 112.

FIG. 2 illustrates an illustrative spatial scalable video encoder 102 which can be used in the camcorder 100, but the invention is not limited thereto. While this illustrative example just has a base layer and one enhancement layer, it will be understood by those skilled in the art that the encoder can have any number of enhancement layers and the invention is not limited thereto. The depicted encoding system 102 accomplishes layer compression, whereby a portion of the channel is used for providing a low resolution base layer and the remaining portion is used for transmitting edge enhancement information, whereby the two signals may be recombined to bring the system up to high-resolution. The high resolution video input is split by splitter 202 whereby the data is sent to a low pass filter 204 and a subtraction circuit 206. The low pass filter 204 reduces the resolution of the video data, which is then fed to a base encoder 208. In general, low pass filters and encoders are well known in the art and are not described in detail herein for purposes of simplicity. The encoder 208 produces a lower resolution base stream which can be broadcast, received and via a decoder, displayed as is, although the base stream does not provide a resolution which would be considered as high-definition.

The output of the encoder 208 is also fed to a decoder 212 within the system 102. From there, the decoded signal is fed into an interpolate and upsample circuit 214. In general, the interpolate and upsample circuit 214 reconstructs the filtered out resolution from the decoded video stream and provides a video data stream having the same resolution as the high-resolution input. However, because of the filtering and the losses resulting from the encoding and decoding, loss of information is present in the reconstructed stream. The loss is determined in the subtraction circuit 206 by subtracting the reconstructed high-resolution stream from the original, unmodified high-resolution stream. The output of the subtraction circuit 206 is fed to an enhancement encoder 216 which outputs an enhancement stream which, when combined with the base stream, renders video with the original high resolution quality.

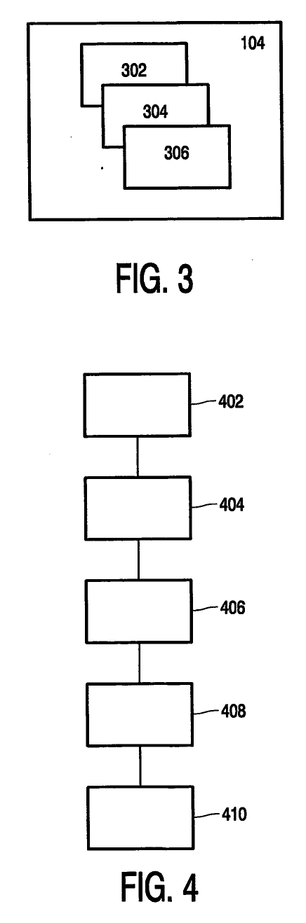

The elastic storage device 104 stores each layer of the encoded video stream, for example, a base layer 302, a first enhancement layer 304 and a second enhancement layer 306, separately as illustrated in FIG. 3. In this embodiment, the base layer video stream and the two enhancement layer video streams are stored separately in the elastic storage device.

The operation of the camcorder 100 will now be described with reference to FIG. 4. The camcorder 100 begins recording and creates an input video signal in step 402. The input video signal is then compressed in a layered manner by the encoder 102 to create layered encoded video streams in step 404. As the layered encoded video streams are created, the streams are stored separately in the elastic storage device 104 in step 406. It will be understood that the different video streams, e.g. the base layer and enhancement layer are stored in blocks in the storage device 104. When storing only the base layer, a bit-rate of X mbps is used and when the enhancement layer is also stored the bit-rate is X+Y mbps. Dependent on the mode (Xmbps or X+Y mbps), the camcorder can indicate the battery lifetime which is still available in step 408. If the battery life is insufficient, the bit-rate is reduced by stopping the storage of at least one of the enhancement layers in step 410. The choice to switch over from the high bit-rate mode (X+Y) to the low bit-rate mode (X) may be done either manually or automatically. For the automatic case, the user has previously indicated to the camcorder the minimal recording time the user still requires using the user interface 114. It will be understood by those skilled in the art that the decision on whether to reduce the bit-rate of the video streams being stored can be made at ant time during the recording process or even before the recording begins. In addition, the decision can be re-evaluated any number of times during the recording process.

According to another embodiment of the invention, the mobile recording apparatus may also be used as a viewing device. It will be understood that the viewing device can also be a variety of mobile video players and the invention is not limited thereto. Instead of recording the video, a mobile video player may download and store video streams that have already been encoded in a layered format by, for example, a content or service provider.

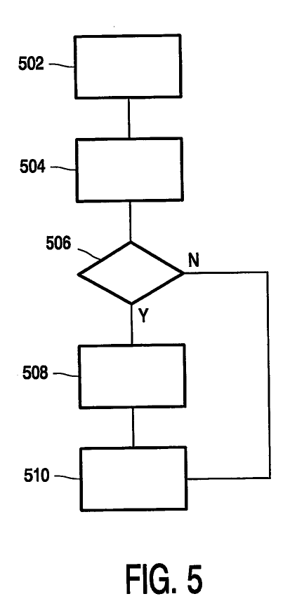

The operation of the viewing device will now be described with reference to FIG. 5. First, the stored video content is selected for display in step 502. In this situation, the length of the piece of video to be viewed can be determined in step 504. If it is determined in step 506 that the video is longer than the available battery life-time, the viewing device switches to a lower quality mode in step 508. In other words, the viewing device stops reading and decoding at least one of the enhancement layers stored in the elastic storage device.

In order for this switch during play-back to be effective on the power consumption, the layered format needs to be such that during skipping of the high quality data the power dissipation is minimal. This can be achieved in a variety of manners. First, blocks of data belonging to the base layer and enhancement layer can written alternately to the disc. The blocks are sufficiently large to allow shut down of the most power demanding circuits in the storage engine, such as the laser, servo, and channel electronics. Second, the enhancement layer data can be written in a separate file on a different location on the disc. This gives the optimal result for this play-back situation. However, during recording and play-back at high quality, this arrangement will have severe negative effects on performance of the drive, due to the continuous switching the system has to do between two files. Third, the start of the base layer blocks on the disc can be positioned an integer number of revolutions of the disc plus a small offset from the end of the previous base layer block. The offset is chosen such that there is sufficient time for the read head to jump between to track where the start of the next base-layer block is located.

It will be understood that the invention is equally applicable in other storage application domains where quality can be scaled, such as audio and still picture. Storage media may be disc and solid state memory. On tape, the invention will also work on the recording side.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

Claims:

1. A method for controlling the recording of data such as streaming data by a mobile recording apparatus, comprising the steps of:
receiving a data input signal;
compressing the data signal in a scalable manner using a scalable encoder to create a scalable encoded data stream;
beginning storage of the scalable encoded data stream in a storage device at a first bit-rate;
determining remaining battery life for the apparatus at the first bit-rate; and
reducing the bit rate of the scalable encoded data stream to a second bit-rate to lengthen the remaining battery life of the apparatus in dependence on the remaining battery life.

2. The method according to claim 1, wherein said data is at least one of video data, audio data, audio/video data.

3. The method according to claim 1, wherein the user manually selects the reduction of the bit-rate.

4. The method according to claim 1, further comprising the steps of:
selecting a predetermined amount of recording time needed, wherein the apparatus automatically switches to a lower bit-rate when the remaining battery life is less than the predetermined amount of recording time.

5. The method according to claim 1, wherein the data signal is compressed in a layered manner using the scalable encoder.

6. A method for displaying stored content on a display, wherein the stored content has been stored in a storage device in a scalable format, the method comprising the steps of:
selecting content to be displayed in a first quality level;
determining a duration of the content selected;
determining remaining battery life for the apparatus;
changing the quality level of the content displayed to a lower quality level when the remaining battery life is less than the duration of the selected content.

7. The method according to claim 6, wherein said content is at least one of video data, audio data, audio/video data.

8. The method according to claim 6, wherein the stored video content is stored in such a manner that power dissipation is minimized during skipping of the enhancement layer data during play-back of the content at the lower quality level.

9. The method according to claim 8, wherein blocks of data belonging to the base layer and at least one enhancement layer are written alternately to the storage device.

10. The method according to claim 8, wherein the at least one enhancement layer is written in a separate file on a different location of the storage device.

11. The method according to claim 8, wherein base layer blocks are positioned a predetermined number of revolutions of a storage device plus a small offset from the end of a previous base layer block.

12. An apparatus for controlling the recording of data such as streaming data by a mobile recording apparatus, comprising:
means for receiving a data input signal;
an encoder for compressing the data signal in a scalable manner to create a scalable encoded data stream;
storage means for beginning storage of the scalable encoded data stream at a first bit-rate;
means for determining remaining battery life for the apparatus at the first bit-rate; and
means for reducing the bit rate of the scalable encoded data stream in dependence on the remaining battery life to a second bit-rate to lengthen the remaining battery life of the apparatus.

13. An apparatus for displaying stored content on a display, wherein the stored content has been stored in a storage device in a scalable format, the apparatus comprising:
means for selecting content to be displayed in a first quality level;
means for determining a duration of the content selected;
means for determining remaining battery life for the apparatus;
means for changing the quality level of the content displayed to a lower quality level when the remaining battery life is less than the duration of the selected content.
